(19) United States
(12) Patent Application Publication
(10) Pub. No.: US 2022/0152615 A1
(43) Pub. Date: May 19, 2022

(54) LOW-TEMPERATURE STORAGE SYSTEM

(71) Applicant: TSUBAKIMOTO CHAIN CO., Osaka (JP)

(72) Inventor: Koichi Ishikawa, Osaka (JP)

(73) Assignee: TSUBAKIMOTO CHAIN CO., Osaka (JP)

(21) Appl. No.: 17/590,344

(22) Filed: Feb. 1, 2022

Related U.S. Application Data
(63) Continuation of application No. PCT/JP2020/019028, filed on May 12, 2020.

(30) Foreign Application Priority Data
Aug. 6, 2019 (JP) 2019-144498

(51) Int. Cl. B01L 9/00; G01N 1/42; G01N 35/00; B65G 1/04; B01L 7/00

(52) U.S. Cl. CPC B01L 9/00; G01N 1/42; B01L 7/50; B65G 1/0407; G01N 35/0099

(57) ABSTRACT

To provide a low-temperature storage system that can, with a simple structure, minimize heat transfer into the low-temperature storage chamber, improve storage space efficiency inside the low-temperature storage chamber, and reduce production and maintenance costs. The low-temperature storage system includes a low-temperature storage chamber, and a moving mechanism that carries storage objects in and out of the chamber. The moving mechanism includes an internal unit, which is made up of a holding part, a lift member that moves the holding part up and down, a reciprocating member that moves the holding part back and forth, and a supplementary moving member that moves storage shelves; and an external unit that transmits driving forces to the internal unit. The holding part, lift member, and reciprocating member are disposed to line up along a moving direction of the supplementary moving member.

### BACKGROUND OF THE INVENTION

### 1. Field of the Invention

The present invention relates to a low-temperature storage system that stores storage objects at low temperatures, and more particularly to a low-temperature storage system that stores samples and the like used in the processes of discovering or designing drugs in medical science, bioengineering, and pharmaceutical sciences, at low temperatures.

### 2. Description of the Related Art

Low-temperature storage systems that store containers accommodating samples at low temperatures have hitherto been known, one of which includes a low-temperature storage chamber having a storage area (lower zone 10) that accommodates a plurality of storage shelves (cassettes 12) for storage objects, and a moving mechanism (lifting device 50) that carries storage objects into and out of the low-temperature storage chamber (see, for example, U.S. Patent Application Publication No. 2010/0183408).

This low-temperature storage system described in U.S. Patent Application Publication No. 2010/0183408 further includes a supplementary moving member (shelf-like support 22) capable of moving the storage shelves (cassettes 12) back and forth in the direction in which the storage shelves (cassettes 12) are open. The moving mechanism (lifting device 50) includes a reciprocating member (longitudinal guide 32) movable back and forth in the same directions as the supplementary moving member (shelf-like support 22), a lateral guide 31 capable of moving back and forth to the front of a plurality of storage shelves (cassettes 12) placed on the supplementary moving member (shelf-like support 22), and a lift member (lift carriage 51) capable of moving up and down by means of a vertical drive 53.

Further, on the moving mechanism (lifting device 50) are arranged a rotary table 61, which can be pivoted about a vertical axis by a semirotary actuator 63, and a holding part (transport scoop 74) horizontally moveable via a scoop drive 73. By moving the supplementary moving member (shelf-like support 22) and moving mechanism (lifting device 50), the holding part (transport scoop 74) carrying a storage object thereon can be moved to a storage position on a storage shelf (cassette 12), or a storage object stored on a storage shelf (cassette 12) can be placed on the holding part (transport scoop 74) and taken out of the storage area (lower zone 10).

Meanwhile, another form of low-temperature storage system that stores containers accommodating samples at low temperatures illustrated in FIG. 10 to FIG. 12 is known, which includes a low-temperature storage chamber 210 having a storage area accommodating a plurality of stationary storage shelves 212 for storage objects, and a moving mechanism that carries storage objects W into and out of the low-temperature storage chamber 210.

In this low-temperature storage system, a reciprocating member 222 that can move a holding part 224 of the moving mechanism back and forth between rows of storage shelves 212 having their open sides facing each other, a lift member 221 that can move the holding part up and down, and a supplementary moving member 223 that can move the holding part toward a storage position on a storage shelf 212 are lined up between the rows of storage shelves 212.

The reciprocating member 222, lift member 221, and supplementary moving member 223 have their respective drive units outside the storage area, so that heat of the drive units does not cause a temperature rise of the storage area as the holding part 224 is operated in the storage area for loading and unloading storage objects W, and also malfunctions of the drive units of the reciprocating member 222, lift member 221, and supplementary moving member 223 caused by exposure to the low-temperature environment in the storage area are prevented.

The device configuration is simple and allows for a reduction in maintenance cost.

### SUMMARY OF THE INVENTION

However, there is some scope of further improvement with the known low-temperature storage system described in U.S. Patent Application Publication 2010/0183408 or the low-temperature storage system shown in FIG. 10 to FIG. 12.

The low-temperature storage system described in U.S. Patent Application Publication 2010/0183408 has the drawback of increased production and maintenance costs because of the complex structure for moving the moving mechanism (lifting device 50).

The drive units such as the semirotary actuator 63 for rotating the rotary table, and the vertical drive 53 for moving the lift member (lift carriage 51) up and down, also go into and out of the storage area (lower zone 10) as they operate to bring the holding part (transport scoop 74) into the storage area (lower zone 10). This led to an inevitable temperature rise in the storage area (lower zone 10) due to the heat generated by the operating semirotary actuator 63 and vertical drive 53, and led to the risk of malfunctions in the semirotary actuator 63 and vertical drive 53 due to the low-temperature environment of the storage area (lower zone 10).

The low-temperature storage system shown in FIG. 10 to FIG. 12 in which storage shelves are arranged with their open sides facing each other allows the number of storage shelves to be increased only in the moving direction of the reciprocating member. If more storage shelves are to be placed in the direction in which the storage shelves face each other, i.e., in the direction crossing the moving direction of the reciprocating member, it was necessary to provide a plurality of moving mechanisms, which would lower the storage space efficiency inside the low-temperature storage chamber.

Moreover, the reciprocating member, lift member, and supplementary moving member lined up between the storage shelves took up large installation space in the direction in which the storage shelves face each other, i.e., in the direction perpendicular to the moving direction of the reciprocating member, because of which the storage space efficiency inside the low-temperature storage chamber was further lowered.

Another drawback was that the reciprocating member, lift member, supplementary moving member, and mechanical components for their movements were provided in a concentrated manner, so that the structure was complex.

The present invention solves these problems, its object being to provide a low-temperature storage system that can, with a simple structure, minimize heat transfer into the low-temperature storage chamber from outside, improve storage space efficiency inside the low-temperature storage chamber, and avoid increase in production and maintenance costs.

The present invention solves the problems described above by providing a low-temperature storage system that stores a storage object held on a storage rack at a low temperature. The low-temperature storage system includes a low-temperature storage chamber accommodating a storage shelf for a storage object held on a storage rack, and a moving mechanism carrying a storage rack holding a storage object thereon into and out of the low-temperature storage chamber. The moving mechanism includes an internal unit installed inside the low-temperature storage chamber in a stationary manner, and an external unit installed outside the low-temperature storage chamber. The internal unit includes a holding part that holds a storage rack carrying a storage object thereon, a lift member capable of moving the holding part up and down, a reciprocating member capable of linearly moving the holding part in directions in which a storage rack holding a storage object thereon is carried into and out of the storage shelf, and a supplementary moving member capable of linearly moving the storage shelf in directions crossing a moving direction of the reciprocating member between a storage position and an unloading position. The external unit includes a vertical motion transmission part capable of transmitting a driving force to the lift member, a reciprocating motion transmission part capable of transmitting a driving force to the reciprocating member, and a supplementary motion transmission part capable of transmitting a driving force to the supplementary moving member. The storage shelf is configured to store a plurality of storage racks along a moving direction of the supplementary moving member and/or a moving direction of the lift member. The holding part is configured to be able to carry out an operation of holding a storage rack only through operations of the lift member and the reciprocating member.

The low-temperature storage system according to claim 1 has a holding part that is configured to be able to move up and down as well as to move linearly in directions in which a storage rack holding a storage object thereon is carried into and out of a storage shelf by means of the lift member and the reciprocating member. The storage shelf has a supplementary moving member whereby it is capable of linearly moving in a direction crossing the moving direction of the reciprocating member. Therefore, the storage shelf can be moved in the direction crossing the moving direction of the holding part when loading or unloading a storage object. The holding part need only move in a total of two directions, i.e., up and down to a matching height of a storage shelf and back and forth in the moving direction of the reciprocating member, to load or unload the storage object.

This allows for a reduction in the space necessary for installation of the moving mechanism in a direction perpendicular to the direction of back and forth movements, so that the storage space efficiency inside the low-temperature storage chamber can be improved.

The storage shelf is configured to be movable linearly in a direction crossing the moving direction of the reciprocating member by means of the supplementary moving member. Moreover, the storage shelf is configured to be able to store a plurality of storage racks along a moving direction of the supplementary moving member and/or a moving direction of the lift member. Therefore, the holding part can load and unload storage objects to and from more storage shelves so that there is no need to provide several rows of moving mechanisms, and thus the storage space efficiency inside the low-temperature storage chamber can be improved more.

The holding part need only move back and forth relative to a storage shelf that has arrived at the unloading position always a fixed amount in the moving direction of the reciprocating member to load or unload a storage object, i.e., can do without fine control of the amount of movement.

Moreover, the holding part is configured to carry out the operation of holding a storage rack only by the operations of the lift member and the reciprocating member. That is, the positioning of the holding part relative to the storage shelf in the supplementary movement direction is achieved by a movement of the storage shelf via the supplementary moving member, so that the holding part is moved in one less direction. Thus the configuration of the holding part can be made small and simple, which enables reduction of production and maintenance costs.

According to the configuration set forth in claim 2, the holding part is disposed closest to the storage position in the internal unit, which reduces the amount of movement of the storage shelf necessary for loading and unloading, and enables efficient loading and unloading of storage objects.

The storage shelf can be moved to the position where the lift member and reciprocating member are disposed. This means that a storage object can be carried into or out of any storage shelf if the low-temperature storage chamber has an internal width equal to the sum of the width of the internal unit and the width of the storage shelves in the moving direction of the supplementary moving member, as long as each of the holding part, lift member, and reciprocating member has the same width as that of the storage shelf in the moving direction of the supplementary moving member, even when, for example, two or more storage shelves are aligned along the moving direction of the supplementary moving member. Thus the storage space efficiency inside the low-temperature storage chamber can be improved.

According to the configuration set forth in claim 3, a plurality of the storage shelves are provided along a moving direction of the reciprocating member, and the supplementary moving member is configured at least to be able to individually move the plurality of storage shelves aligned along the moving direction of the reciprocating member. When moving a target storage shelf to the unloading position for loading or unloading a storage object, at least the storage shelves adjacent the target storage shelf in the loading/unloading direction may be controlled not to move, which will secure enough room for the holding part to carry out reliable loading and unloading.

According to the configuration set forth in claim 4, the storage shelf includes a main storage shelf disposed on a side closer to the holding part in the internal unit, and a sub storage shelf positioned on an opposite side of the internal unit from the main storage shelf. The supplementary moving member is configured at least to be able to move the main storage shelf and the sub storage shelf positioned on opposite sides of the internal unit relative to each other. Therefore, as long as the width of the main storage shelf and the width of the sub storage shelf are equal to or smaller than the width of the internal unit, one internal unit between the main storage shelf and the sub storage shelf can carry in or out storage objects to or from both of the main storage shelf and sub storage shelf. There is no need to add an internal unit, which allows for a reduction in production cost, and further improves the storage space efficiency inside the low-temperature storage chamber.

### BRIEF DESCRIPTION OF THE DRAWINGS

FIG. 1 is a perspective view of a low-temperature storage system 100 according to one embodiment of the present invention;

FIG. 2 is a perspective view of the low-temperature storage system 100 according to one embodiment of the present invention, without the low-temperature storage chamber 110;

FIG. 3 is a diagrammatic top view of the low-temperature storage system 100 according to one embodiment of the present invention;

FIG. 4 is a diagrammatic front view of the low-temperature storage system 100 according to one embodiment of the present invention;

FIG. 5 is a diagrammatic side view of the low-temperature storage system 100 according to one embodiment of the present invention;

FIG. 6 is a diagrammatic top view of a transport step in the low-temperature storage system 100 according to one embodiment of the present invention;

FIG. 7 is a diagrammatic front view of the transport step in the low-temperature storage system 100 according to one embodiment of the present invention;

FIG. 8 is a diagrammatic front view of the transport step in the low-temperature storage system 100 according to one embodiment of the present invention, in which a storage rack holding a storage object W rests on the holding part 124;

FIG. 9 is a diagrammatic top view of the transport step in the low-temperature storage system 100 according to one embodiment of the present invention, in which a sub storage shelf 112b is being operated;

FIG. 10 is a diagrammatic top view of a conventional low-temperature storage system 200;

FIG. 11 is a diagrammatic front view of the conventional low-temperature storage system 200; and

FIG. 12 is a diagrammatic side view of the conventional low-temperature storage system 200.

### DESCRIPTION OF THE PREFERRED EMBODIMENTS

A low-temperature storage system 100 according to one embodiment of the present invention will be hereinafter described with reference to the drawings.

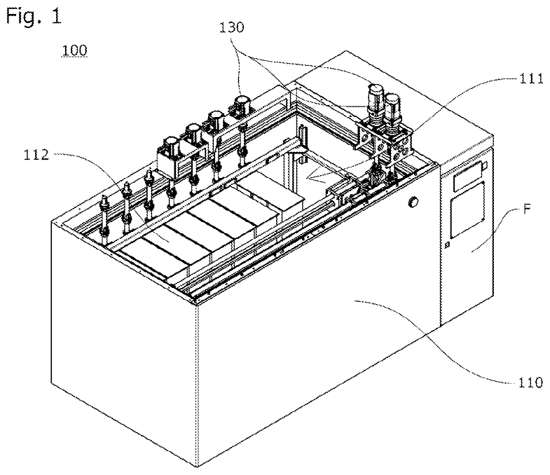

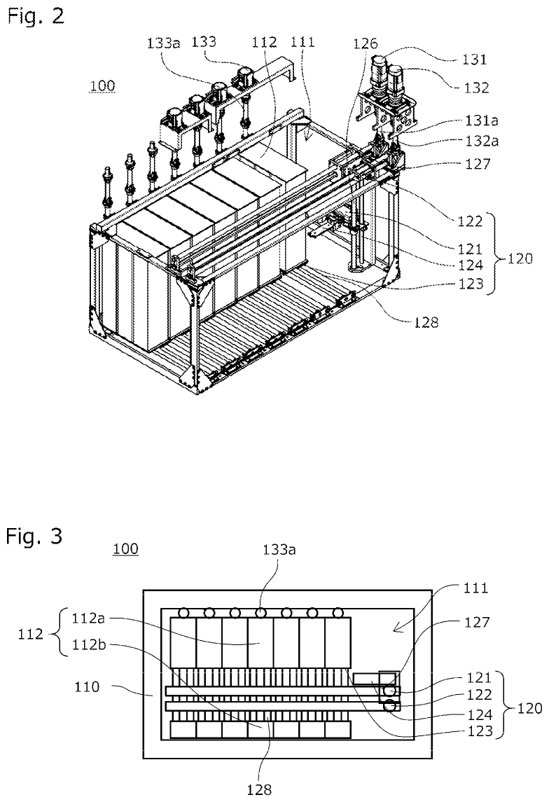

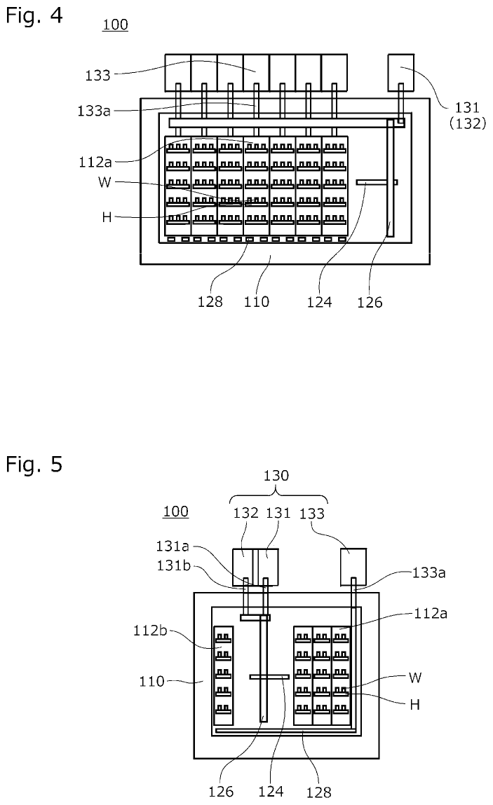

The low-temperature storage system 100 that is one embodiment of the present invention stores storage objects W at low temperatures, and includes, as illustrated in FIG. 1 to FIG. 5, a low-temperature storage chamber 110 accommodating storage shelves 112 for storage objects W, a freezer F that cools the interior of the low-temperature storage chamber, and a moving mechanism carrying storage objects W into and out of the low-temperature storage chamber 110.

The low-temperature storage chamber 110 has an opening part 111 that is open to the area above.

The moving mechanism includes an internal unit 120 installed inside the low-temperature storage chamber 110 in a stationary manner, and an external unit 130 installed outside the low-temperature storage chamber 110.

The internal unit 120 includes a holding part 124 that holds a storage object W, a lift member 121 capable of moving the holding part 124 up and down, a reciprocating member 122 capable of linearly moving the holding part 124 in directions in which the storage objects W are carried into and out of storage shelves 112, and a supplementary moving member 123 capable of linearly moving the storage shelves 112 in directions crossing the moving directions of the reciprocating member 122 between a storage position and an unloading position.

The lift member 121 is configured to be movable up and down along a vertical motion guide 126.

The reciprocating member 122 is configured to be linearly movable along a reciprocating motion guide 127.

The supplementary moving member 123 is configured to be linearly movable along a supplementary motion guide 128.

The external unit 130 includes a vertical motion transmission part 131 that generates a driving force for the lift member 121, a reciprocating motion transmission part 132 that generates a driving force for the reciprocating member 122, and a supplementary motion transmission part 133 that generates a driving force for the supplementary moving member 123. The vertical motion transmission part 131 transmits the driving force to the lift member 121 via a vertical motion transmission guide 131a, the reciprocating motion transmission part 132 transmits the driving force to the reciprocating member 122 via a reciprocating motion transmission guide 132a, and the supplementary motion transmission part 133 transmits the driving force to the supplementary moving member 123 via a supplementary motion transmission guide 133a.

Since the vertical motion transmission part 131, reciprocating motion transmission part 132, and supplementary motion transmission part 133 that generate driving forces are always located outside of the low-temperature storage chamber 110, heat generated by the external unit 130 is prevented from being conducted into the low-temperature storage chamber 110, so that a temperature rise in the low-temperature storage chamber 110 is prevented, and energy consumption for maintaining the low temperature can be kept low.

The holding part 124 is mounted to the vertical motion guide 126 such that it can be moved up and down by the lift member 121, as well as back and forth, by the reciprocating member 122 moving the whole vertical motion guide 126 back and forth.

The holding part 124, lift member 121, and reciprocating member 122 are disposed to line up along a moving direction of the supplementary moving member 123.

The storage shelves 112 are disposed at storage positions in the low-temperature storage chamber 110 and open toward directions in which the holding part 124 moves back and forth. The storage shelves include a main storage shelf 112a located closer to the holding part 124 and a sub storage shelf 112b on the opposite side of the holding part 124 from the main storage shelf 112a, each of which is configured to be able to move linearly along the supplementary motion guide 128 independently to an unloading position by means of the supplementary moving member 123.

The storage shelves 112 are configured to be able to accommodate a plurality of storage objects W held on storage racks H.

The main storage shelves 112a are three times larger in the longitudinal direction of the supplementary motion guide 128 than the sub storage shelves 112b. The internal unit 120 has the same width as the main storage shelves 112a in the longitudinal direction of the supplementary motion guide 128.

Since the storage shelves 112 are configured to be moved by the supplementary moving member 123, the holding part 124 is moved in one less direction, so that the configuration of the holding part 124 can be made smaller and simpler, which allows for reduction of production and maintenance costs.

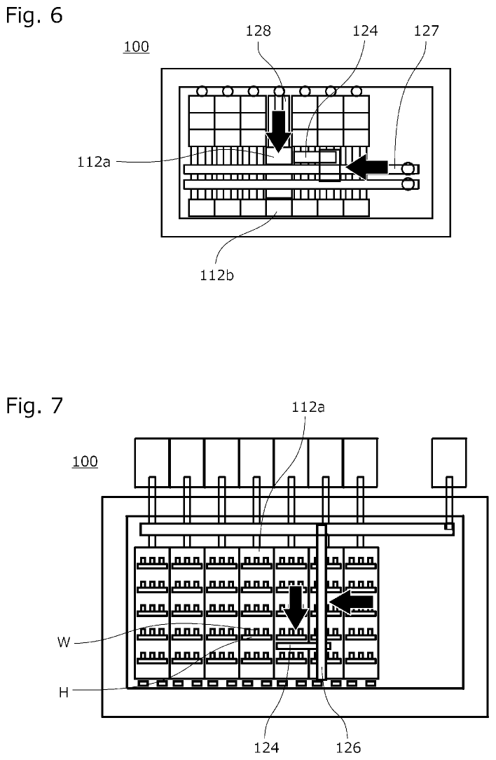

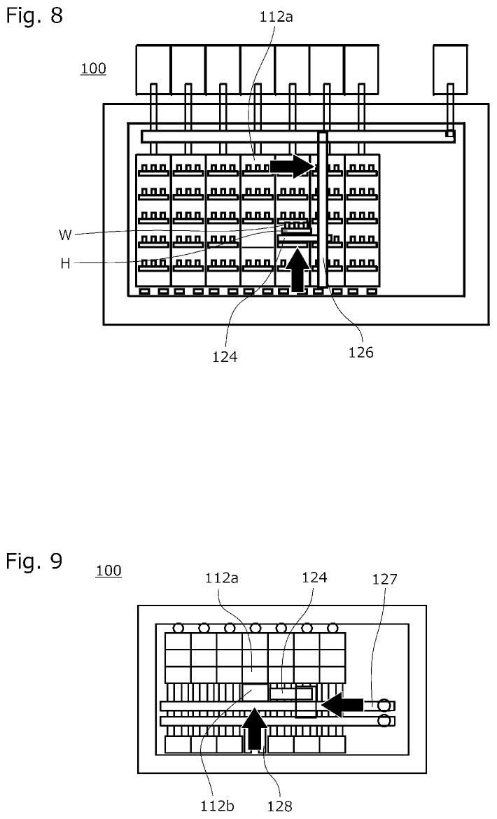

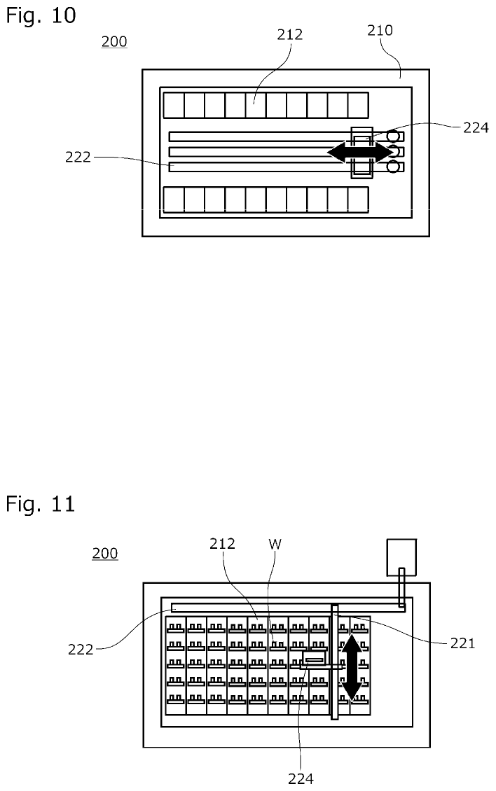

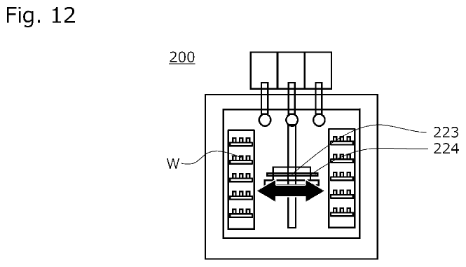

Next, a method of transporting storage objects W inside the low-temperature storage chamber 110 using the low-temperature storage system 100 of the present invention is described with reference to FIG. 6 to FIG. 9.

First, as shown in FIG. 6 and FIG. 7, a main storage shelf 112a on which a storage object W to be transported rests is moved from a storage position by the supplementary moving member 123.

At this time, the storage shelf 112a is moved such far that the storage object W reaches a position where the holding part 124 moves back and forth, i.e., to an unloading position.

Next, the holding part 124 is moved toward the main storage shelf 112a by the reciprocating member 122.

At this time, the holding part 124 may be moved by the lift member 121 to a height matching that of the storage rack H holding the storage object W to be transported at the same time with the movement by the reciprocating member 122.

The holding part 124 slides in below the storage rack H holding the storage object W to be transported by means of the reciprocating member 122, and lifts up the storage rack H by means of the lift member 121, after which the holding part 124 moves away from the main storage shelf 112a again by means of the reciprocating member 122.

This way, the whole storage rack H holding the storage object W to be transported can be carried out of the main storage shelf 112a.

The holding part 124 on which the whole storage rack H rests is then moved to the opening part 111 so that the storage object W carried out of the main storage shelf 112a can be taken out of the low-temperature storage chamber 110.

By carrying out this operation in reverse manner, a storage object W can be brought into a main storage shelf 112a from outside of the low-temperature storage chamber 110.

A sub storage shelf 112b may also be moved by the supplementary moving member 123 such as to allow a storage object W to reach a position where the holding part 124 moves back and forth as shown in FIG. 9 so that the storage object is carried in and out of a sub storage shelf 112b.

The main storage shelves 112a are three times larger in the longitudinal direction of the supplementary motion guide 128 than the sub storage shelves 112b, and the internal unit 120 has the same width as the main storage shelves 112a in the longitudinal direction of the supplementary motion guide 128. Therefore, the sub storage shelf 112b does not interfere with the main storage shelf 112a as the storage object W is loaded or unloaded.

When taking out a storage object W placed at a farthest end of a main storage shelf 112a from the holding part 124, the main storage shelf 112a may be moved to a position where it is entirely below the internal unit 120 so that it does not interfere with the sub storage shelf 112b.

This way, as compared to cases where open sides of storage shelves face each other on both sides of the holding part, the number of storage shelves that can be dealt with by one holding part can be increased. Since there is no need to provide a plurality of internal units inside the low-temperature storage chamber, the area where storage objects W are placed inside the low-temperature storage chamber can be enlarged, and thus the storage space efficiency can be improved.

While one embodiment of the present invention has been described above in detail, the present invention is not limited to the embodiment described above. Various design changes may be made without departing from the scope of the present invention set forth in the claims.

In the embodiment described above, the storage shelves are open toward directions in which the holding part moves back and forth, and include main storage shelves located closer to the holding part and sub storage shelves on the opposite side of the holding part from the main storage shelves. The storage shelves are not limited to this configuration. For example, the storage shelves may be provided only on one side of the holding part, or, the storage shelves may be provided on both sides of the holding part as well as on end portions in the directions in which the holding part moves back and forth.

While the low-temperature storage chamber is provided with the opening part that is open to the area above in the embodiment described above, the opening part is not limited to this position or configuration. For example, a work area to which the holding part can move to may be provided above the storage shelves inside the low-temperature storage chamber, and an opening part that is open to one side of the work area may be provided. Optionally, a shutter may be provided to the opening part so that the opening part can be opened and closed.

While the main storage shelves have a width three times larger than that of the sub storage shelves in the embodiment described above, the main storage shelves and sub storage shelves are not limited to this configuration. For example, the main storage shelves may have a width twice larger than that of the sub storage shelves, and the main storage shelves and sub storage shelves may be configured movable to the unloading position without interfering with each other.

While the internal unit has the same width as that of the main storage shelves in the longitudinal direction of the supplementary motion guide in the embodiment described above, the relationship between the widths of the internal unit and the storage shelves may be otherwise as long as main storage shelves and sub storage shelves are configured movable to the unloading position without interfering with each other. For example, the internal unit may have a smaller width than the main storage shelves, and the distance between the main storage shelves and the sub storage shelves located at the storage positions may be longer than the width of the main storage shelves.

While the main storage shelves are three times larger in the longitudinal direction of the supplementary motion guide than the sub storage shelves in the embodiment described above, the relationship between the main storage shelves and the sub storage shelves may be otherwise as long as main storage shelves and sub storage shelves are configured movable to the unloading position without interfering with each other. For example, the main storage shelves may be twice larger in the longitudinal direction of the supplementary motion guide than the sub storage shelves, or, the main storage shelves may have the same size as the sub storage shelves.

The holding part slides in below the storage rack, lifts up the storage rack, and moves away from the main storage shelf to unload the storage rack carrying the storage object thereon in the embodiment described above. The method of transporting the storage object is not limited to this. For example, a chuck may be attached to the holding part so that a storage object alone is gripped and transported directly by the chuck, or, a hook may be attached to the holding part to be hooked to a hook hole provided to the storage object to transport the storage object.

The main storage shelves and sub storage shelves are configured to be able to move linearly to the unloading position individually along the supplementary motion guide by the supplementary moving member in the embodiment described above. The main storage shelves and sub storage shelves are not limited to this configuration. For example, several main storage shelves and sub storage shelves may move at the same time as long as there is spacing so that they do not interfere with the internal unit when loading and unloading the storage objects.

What is claimed is:

1. A low-temperature storage system that stores a storage object held on a storage rack at a low temperature, comprising:
a low-temperature storage chamber accommodating a storage shelf for a storage object held on a storage rack inside; and a moving mechanism carrying a storage rack holding a storage object thereon into and out of the low-temperature storage chamber,
the moving mechanism including an internal unit installed inside the low-temperature storage chamber in a stationary manner, and an external unit installed outside the low-temperature storage chamber,
the internal unit including a holding part that holds a storage rack carrying a storage object thereon, a lift member capable of moving the holding part up and down, a reciprocating member capable of linearly moving the holding part in directions in which a storage rack carrying the storage object held thereon is carried into and out of the storage shelf, and a supplementary moving member capable of linearly moving the storage shelf in directions crossing a moving direction of the reciprocating member between a storage position and an unloading position,
the external unit including a vertical motion transmission part capable of transmitting a driving force to the lift member, a reciprocating motion transmission part capable of transmitting a driving force to the reciprocating member, and a supplementary motion transmission part capable of transmitting a driving force to the supplementary moving member,
the storage shelf being configured to store a plurality of storage racks along a moving direction of the supplementary moving member and/or a moving direction of the lift member,
the holding part being configured to be able to carry out an operation of holding a storage rack only through operations of the lift member and the reciprocating member.

2. The low-temperature storage system according to claim 1, wherein the holding part is disposed closest to the storage position in the internal unit.

3. The low-temperature storage system according to claim 1, wherein a plurality of the storage shelves are provided along a moving direction of the reciprocating member,
the supplementary moving member being configured at least to be able to individually move the plurality of storage shelves aligned along the moving direction of the reciprocating member.

4. The low-temperature storage system according to claim 2, wherein the storage shelf includes a main storage shelf disposed on a side closer to the holding part in the internal unit, and a sub storage shelf positioned on an opposite side of the internal unit from the main storage shelf,
the supplementary moving member being configured at least to be able to move the main storage shelf and the sub storage shelf positioned on opposite sides of the internal unit relative to each other.
